(19) United States
(12) Patent Application Publication
(10) Pub. No.: US 2007/0196554 A1
(43) Pub. Date: Aug. 23, 2007

(54) Processed cheeses comprising dietary fiber gel

(76) Inventor: Triveni P. Shukla, Mukwonago, WI (US)

Correspondence Address: Timothy J. Fullin J.D., LL.M., 1011 Campus Drive, Mundelein, IL, 60060, US

(21) Appl. No.: 11/788,233

(22) Filed: Apr. 19, 2007

Related U.S. Application Data
(63) Continuation-in-part of application No. 11/251,638, filed on Oct. 14, 2005.
Application No. 11/251,638 is a continuation-in-part of application No. 10/879,662, filed on Jun. 28, 2004, now abandoned.

(51) Int. Cl. A23C 19/00

(52) U.S. Cl. 426/582

(57) ABSTRACT

According to the present invention, fat and caloric content of processed cheese sauce can be reduced by the replacement of a portion fat content normally found in processed cheese sauce with an amount of dietary fiber gel. The result is that fat and caloric content of processed cheeses can be manipulated with minimal effect on taste and texture. Furthermore, the processed cheese sauce can further comprise functional foods that increase health and nutritional benefits of the processed cheeses. The functional foods can be added individually, and in any combination thereof. Hence, in addition to reducing fat and caloric content of processed cheese sauce by replacing a portion of fat with dietary fiber gel, additional health benefits can be achieved with compositions that include functional foods.

### B. CROSS-REFERENCE TO RELATED APPLICATIONS

This application is a Continuation-in-Part Application of U.S. patent application Ser. No. 11/251,638 filed on Oct. 14, 2005, the entirety of which is incorporated herein and which is in turn a Continuation-in-Part Application of U.S. patent application Ser. No. 10/879,662 filed on Jun. 28, 2004, the entirety of which is also incorporated herein.

### C. STATEMENT REGARDING FEDERALLY SPONSORED RESEARCH/DEVELOPMENT

The present invention does not involve any form of federally sponsored research or development.

### D. BACKGROUND OF THE INVENTION

The present invention relates to processed cheese sauce comprising dietary fiber gel. Recent media attention to the global problem of obesity demonstrates a need for greater availability of foods with low caloric and fat content. This is especially true for foods that typically have high fat and caloric content, such as processed cheeses and cheese sauces.

Processed cheese sauces typically comprise some fat. Other ingredients can vary according to the type of processed cheese sauce and the recipe followed, but typically, processed cheese sauces are high in both fat and caloric content. Examples of processed cheeses include but are not limited to processed cheese food, spreadable cheese foods and the like.

Some efforts toward replacing the fat normally found in cheese sauce have involved the use of dietary fiber gels. These efforts have generally proven unsuccessful because dietary fiber generally imparts a gritty texture, undesirable flavor and/or other characteristics that render low-fat products unpalatable to consumers.

Fiber is well-known in the art to comprise two distinct classes, namely, soluble and insoluble. More specifically cellulose comprises crystalline regions and amorphous regions. The crystalline regions are highly ordered and generally are insoluble, while the amorphous regions are generally less ordered and are generally soluble. The fiber used in the instant invention is insoluble, i.e., crystalline fiber, that has been rendered amorphous despite its retention of insoluble attributes. For instance, when the fiber of the instant invention is tested analytically, the predominant compositional element is crude (insoluble) fiber, yet scanning electron microscopy and birefringence analysis demonstrate the amorphous nature of the present fiber, as does the fact that the Inglett dietary fiber readily gels to form a highly viscous gel with a large hydration capacity.

The term “amorphous” is a well-known term of art in the dietary fiber industry, and a person of ordinary skill in that art would understand “amorphous”, when used to modify the words “fiber” and “cellulose”, to mean “non-crystalline”. “Amorphous”, in this context is synonymous with “non-crystalline”. See, for example, Martin Chaplin, Cellulose (visited Jan. 18, 2007) <http://www.lsbu.ac.uk/water/hycel.html>, Mark Davis et al., Changes in Cellulose Morphology of Pretreated Yellow Poplar During Enzymatic Hydrolysis (visited Jan. 18, 2007) <http://wwwl.eere.energy.gov/biomass/pdfs/po32125.pdf>, and Abstract, Molecular Modeling of Cellulose in Amorphous State. Wei Chen et al., POLYMER, Volume 45, Issue 3, February 2004.

Prior to the invention of the amorphous insoluble dietary fiber gels as described in U.S. Pat. No. 5,766,662 (the '662 patent), it was well known in the art that soluble fiber necessarily tends to have hydration capacities and viscosities higher than crystalline insoluble fiber. For example, Loh et al. teach a gel comprising insoluble (i.e., crystalline) fiber and a substantially linear soluble polymeric polysaccharide (i.e., soluble fiber). See, for example, the Abstract of U.S. Pat. No. 6,149,962, as well as Column 1 line 66 through Column 2 Line 3. Loh et al. teach insoluble material being present up to 15% by weight of the total composition. Column 2, Lines 9-10. Although Loh et al. teach microparticulation, there is no teaching of morphological disintegration as required by the Inglett patent, as incorporated by reference in the present application. Loh et al. further teach that substantial amounts, between 10% and 50%, of soluble polymeric polysaccharides are required to reach the full functionality of the gel. Column 2 at lines 3-10. Therefore the fiber taught by Loh et al. requires a relatively high amount of solids be added to a given food formulation in order to reach its full functionality with respect to viscosity and hydration. This tends to impart a gritty texture.

Accordingly, there is a need for a reduced fat and caloric content processed cheese sauce that have the desirable flavor and texture of high fat and high caloric content processed cheeses.

### E. BRIEF SUMMARY OF THE INVENTION

A composition of matter for use as a fiber-fortified, low-calorie and low-fat processed cheese sauce is provided. The composition includes dietary fiber gel that replaces fat in processed cheese sauce. In addition, compositions are provided that include dietary fiber gel and other functional ingredients for nutritionally fortified processed cheese sauces.

Dietary fiber gels for calorie reduced foods hold the key to meeting this need. Dietary fiber gels for calorie reduced foods are fully described in U.S. Pat. No. 5,766,662 (the '662 patent), which is herein incorporated by reference in its entirety. These dietary fiber gels comprise insoluble dietary fibers consisting of morphologically disintegrated cellular structures, and are characterized by their ability to retain large amounts of water. These amorphous insoluble cellulosic fiber gels are produced by shearing agricultural by-products, such as seed brans, hulls, and so forth, under alkaline conditions. Amorphous insoluble cellulosic fiber gels in a hydrated form can exist as gel, and in the dehydrated form as flakes and powders. Additionally, their high viscosity at low solid levels characterizes these dietary fiber gels. Other insoluble fibers derived from cereals, grains and legumes, including those disclosed in U.S. Pat. No. 6,149,962, consist of morphologically in tact cellular structures, and thus impart a gritty texture to the foods in which they are contained. In some cases, these insoluble fibers require the addition of large amounts of soluble polysaccharides and fibers in order to achieve full functionality. The amorphous insoluble cellulosic fiber gels disclosed in the '662 patent (also herein referred to as dietary fiber gels), however, are amorphous in nature and consist of morphologically disintegrated cellular structures; they thus impart a smoother texture than other insoluble fiber formulations. The physically smooth morphology is readily revealed under electron microscopic magnification of amorphous insoluble cellulosic fiber gel. The amorphous nature of the cellulosic fiber is also demonstrated by approximately 60 percent to 90 percent reduction in birefringence when compared to microcrystalline dietary fiber products. The smooth morphology reflects the amorphous nature of the insoluble compounds that constitute amorphous insoluble cellulosic fiber gel.

The physical characteristics of the Inglett dietary fiber, that is, the amorphous insoluble fiber, make it a particularly effective material for use in cheese sauce. It is well-known in the art of cheese-making that cheese comprises a protein called casein. In fact, the etymology of the very word casein likely derives from the Latin word for cheese, caseus. See, for example, Merriam Webster Online Dictionary, <http://www.m-w.com/dictionary/casein>. The structure of casein is likewise known in the art of cheese-making to have a structure known as a “micelle”. Micelles are known to be generally hydrophobic agglomerations of sub-micelles, although there is some ongoing debate over whether sub-micelles retain their respective individual structures after joining the agglomeration. See, for example, University of Guelph, Dairy Chemistry and Physics (visited Jan. 16, 2007), <http://www.foodsci.uoguelph.ca/dairyedu/chem.html> and University of Guelph, Casein Micelle Structure (visited Jan. 16, 2007), <http://www.foodsci.uoguelph.ca/deacon/casein.html>.

The Inglett fiber as employed in the instant invention is nearly 70% crude fiber. Crude fiber is widely known, both in and out of the art, to be insoluble and either hydrophobic or at least not hydrophilic. Rather, crude fiber is expected, by those knowledgeable in the art of dietary fiber usage, to form a suspension in aqueous systems wherein the crude fiber will ultimately settle to the bottom of the system. Inglett's fiber, however, has been rendered largely amorphous: it has been “solublized”. The amorphous regions act in a hydrophilic manner whilst the portions retaining crystalline structure remain either neutral or hydrophobic. This is significant to how the fiber used in the instant invention interacts with hydrophobic casein. Owing to the retained crystalline regions, the Inglett fiber retains the ability to interact with interior portions of the casein micelles. Additionally, owing to the significant amorphous regions present in Inglett's fiber, it has the ability to interact with hydrophilic elements found in cheese, including exterior hydrophilic portions of casein micelles. This dual nature of the fiber employed by the present invention is critical to maximize the functioning of dietary fiber gels in cheese sauce, and provides for the unexpected result that utilization of relatively large amounts of insoluble fiber in cheese sauce produces smooth, non-gritty sauce.

According to the present invention, fat and caloric content can be reduced by the replacement of the fat normally found in cheese sauce with dietary fiber gel. This replacement of fat does not adversely affect either the taste or texture of the cheese sauce. In fact, the added dietary fiber gel helps to increase the moisture content of the cheese sauce while simultaneously lowering the fat content. The result is that fat and caloric content of cheese sauce can be manipulated with minimal effect on taste and texture, and as stated herein, additional health benefits can be achieved through consumption of cheese sauce comprising dietary fiber gel and water when functional foods are included in the formulations.

Further objects, advantages and features of the present invention will present themselves in the following detailed description.

### F. DETAILED DESCRIPTION OF THE PREFERRED EMBODIMENT

The following description provides for the use of dietary fiber gels for fat and calorie reduced processed cheeses. When substituted for fat containing compounds, dietary fiber gels reduce the fat and calorie content of food products. Dietary fiber gels are fully described in U.S. Pat. No. 5,766,662 (the '662 patent), which is incorporated by reference herein. These dietary fiber gels comprise insoluble dietary fibers consisting of morphologically disintegrated cellular structures, and are characterized by their ability to retain large amounts of water. The dietary fiber gels are produced by shearing agricultural by-products, such as seed brans, hulls, and so forth, under alkaline conditions. Dietary fiber gels in a hydrated form can exist as a gel, and in the dehydrated form as flakes and powders. Dietary fiber gels are characterized by high hydration capacity when reconstituted with water. Additionally, these dietary fiber gels are characterized by their high viscosity at low solid levels. Other insoluble fibers derived from cereals, grains and legumes derived by conventional dry milling consist of morphologically in tact cellular structures, and thus impart a gritty texture to the foods in which they are contained. The dietary fiber gels disclosed in the '662 patent, however, consist of morphologically disintegrated cellular structures and thus impart a smoother texture than other insoluble fiber formulations. A physically smooth morphology is readily revealed under electron microscopic magnification of dietary fiber gel. The smooth morphology reflects the amorphous nature of the non-particulate insoluble compounds that constitute dietary fiber gel.

The physical characteristics of the Inglett dietary fiber, that is, the amorphous insoluble fiber, make it a particularly effective material for use in cheese sauce. It is well-known in the art of cheese-making that cheese comprises a protein called casein. In fact, the etymology of the very word casein likely derives from the Latin word for cheese, cases See, for example, Merriam Webster Online Dictionary, <http://www.m-w.com/dictionary/casein>. The structure of casein is likewise known in the art of cheese-making to have a structure known as a “micelle”. Micelles are known to be generally hydrophobic agglomerations of sub-micelles, although there is some ongoing debate over whether sub-micelles retain their respective individual structures after joining the agglomeration. See, for example, University of Guelph, Dairy Chemistry and Physics (visited Jan. 16, 2007), <http://www.foodsci.uoguelph.caldairyedu/chem.html> and University of Guelph, Casein Micelle Structure (visited Jan. 16, 2007), <http://www.foodsci.uoguelph.ca/deacon/casein.html>.

The Inglett fiber as employed in the instant invention is nearly 70% crude fiber. Crude fiber is widely known, both in and out of the art, to be insoluble and either hydrophobic or at least not hydrophilic. Rather, crude fiber is expected, by those knowledgeable in the art of dietary fiber usage, to form a suspension in aqueous systems wherein the crude fiber will ultimately settle to the bottom of the system. Inglett's fiber, however, has been rendered largely amorphous: it has been “solublized”. The amorphous regions act in a hydrophilic manner whilst the portions retaining crystalline structure remain either neutral or hydrophobic. This is significant to how the fiber used in the instant invention interacts with hydrophobic casein. Owing to the retained crystalline regions, the Inglett fiber retains the ability to interact with interior portions of the casein micelles. Additionally, owing to the significant amorphous regions present in Inglett's fiber, it has the ability to interact with hydrophilic elements found in cheese, including exterior hydrophilic portions of casein micelles. This dual nature of the fiber employed by the present invention is critical to maximize the functioning of dietary fiber gels in cheese sauce, and provides for the unexpected result that utilization of relatively large amounts of insoluble fiber in cheese sauce produces smooth, non-gritty sauce.

According to the present invention, fat and caloric content can be reduced by the replacement of the fat-containing ingredients normally found in processed cheeses with dietary fiber gel. Substituting dietary fiber gel for fat does not adversely affect either the taste or texture of the processed cheeses.

Processed cheeses can be formulated such that the processed cheese comprises 0.1 percent to 6.0 percent dietary fiber gel solids by replacing an appropriate amount, that is, an amount prorated to deliver this range of dietary fiber gel solids, of fat, including oil and liquid shortening, with dietary fiber gel. The result is that fat and caloric content of processed cheeses can be manipulated with minimal effect on taste and texture, and as stated above, additional health benefits can be achieved through consumption of processed cheeses comprising dietary fiber gel when functional foods are included in the formulations.

Functional ingredients can be added to the composition of processed cheeses to increase health and nutritional benefits of this food. Most notably functional foods such as high omega three and omega six oils and pure omega three and omega six fatty acids, medium chain triglyceride, beta carotene, calcium stearate, vitamin E, bioflavonoids, fagopyritrol, polyphenolic antioxidants of vegetable origin, lycopene, luteine and soluble fiber, for example Beta-Glucan derived from yeast, and other soluble fibers derived from grain, flax seed, and other vegetable and fruit fiber sources can be added to processed cheeses.

The following ranges of the functional foods in processed cheeses are given by way of example, but other functional foods, notably fat soluble functional foods, can be added as well. High omega three oils and omega six oils, for example flax seed oil, can be added in concentrations of 1 percent to 50 percent of the composition by weight. Pure omega three fatty acids and omega six fatty acids can be added in concentrations ranging from 1 percent to 30 percent of the composition by weight. If both pure omega three or six fatty acids and high omega three oils are used, their respective concentrations can be prorated to give an appropriate end concentration of high omega three fatty acids. Medium chain triglyceride can be added in concentrations ranging from 1 percent to 30 percent of the composition by weight. Fagopyritrol or foods containing fagopyritrol can be added in concentrations of 0.25 percent to 20 percent of the composition by weight. Polyphenolic antioxidants of vegetable origin, for example lycopene, beta carotene, luteine, and bioflavonoids can be added in concentrations ranging from 0.25 percent to 20 percent of the composition by weight. Soluble fiber, for example beta Glucan, can be added in concentrations ranging from 5 percent to 15 percent of the composition by weight. Any functional foods added to the composition can be added in such concentrations to deliver up to 100 percent, preferably 25 percent to 100 percent, of prevailing recommended daily intake recommendations by the FDA (Food and Drug Administration of the United States), European Commission, and reported by the FAO (Food and Agricultural Organization of the United Nations) in the Codex Alimentarius, or other international authorities.

Although the present invention is illustrated by the example of processed cheeses, processed cheese spreads, and so forth, the present invention applies to foods and food formulations that include fat containing ingredients such as oils, greases, and lards that are derived from vegetable, animal, or synthetically produced that are used in the mixing, blending, fermenting or other processing as necessary to produce edible foods.

An advantage of the present invention is the ability to provide a unique composition of matter embodied by low-calorie and low-fat processed cheeses. The fat and caloric content are advantageously reduced by the replacement of the fat normally found in processed cheeses with compositions comprising dietary fiber gel. Food compositions that reduce caloric and fat content answer an unmet need in the food industry to provide the consuming public with a healthier, higher fiber alternative to traditional types of processed cheeses that typically are inherently fattening. Another advantage is the providing processed cheeses that have been fortified with insoluble fiber and other functional foods. Yet another advantage is that the fat replacement with dietary fiber gel does not adversely affect either the taste or texture of processed cheeses. Finally, the fat and caloric content of processed cheeses can be advantageously manipulated with minimal adverse effect on taste and texture, and additional health benefits can be achieved through composition of processed cheeses comprising dietary fiber gel when functional foods are included in the formulations.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

### EXAMPLE 1

### Cheese Sauce Comprising Dietary Fiber Gel

TABLE 1

| | Weight % | Weight % | |
|---|---|---|---|
| Ingredient | Without | With | Remarks 1 |
| Full fat Cheddar | 67.00 | 31.55 | |
| Cheese, 33% Fat | | | |
| Low fat Cheese, | — | 27.00 | |
| 7% Fat | | | |
| Enzyme modified | — | 0.50 | Compensates |
| Cheese | | | for any dilution |
| | | | of flavor. |
| Dietary Fiber Gel | — | 2.20 | |
| Disodium Phosphate | 1.80 | 1.80 | |
| Trisodium Phosphate | 0.54 | 0.54 | |
| Salt | 0.50 | 0.75 | |
| Skim Milk Powder | 7.63 | 8.63 | |
| Sweet Whey Powder | 4.50 | 4.25 | |
| Cream, 40% fat | 2.00 | 1.00 | |
| Water | 4.00 | 10.57 | |
| Water from Steam | 8.00 | 7.00 | |
| Lactic Acid | 4.00 | 4.25 | |
| Color | 0.03 | 0.04 | |
| Total | 100.00 | 100.00 | |
| Percent Fat | 22.91 | 12.30 | |

PROCEDURE: To a Warring Blender add water, lactic acid and Dietary Fiber Gel powder. Blend at low speed in order to incorporate all water as a very thick gel. Add the gel to the rest of ingredients all ready in the processed cheese heat-exchanger processor. Heat and cook for 45 minutes with direct good quality steam injection (this is what accounts for water from steam). Examine the finished product for sheating, slicing, shredding, and melting.

Two formulations of Cheese Sauce are presented in Table 1. One sauce formulation, labeled here as “Without”, represents a typical formulation for Cheese sauce. A Cheese sauce formulation, labeled here as “With”, demonstrates a variation on the “Without” formulation and comprises Dietary Fiber Gel. The formulation comprising Dietary Fiber Gel exhibits a 46.3% reduction in fat compared to its counterpart formulation and comprises 2.20% (by weight) amorphous insoluble cellulosic fiber gel solids. Thus, in addition to eliminating over 46% of the fat from a representative typical Processed Cheese sauce formulation, healthy dietary fiber has been added, making the “With” formulation a vehicle of delivery for insoluble dietary fiber.

I claim:

1. Processed cheese sauce, the cheese sauce having a formulation, the cheese sauce comprising insoluble amorphous dietary fiber gel,
wherein the dietary fiber gel is added in a prorated amount such that solids contained within the dietary fiber gel represent 0.1 percent to 3.5 percent by weight of the overall processed cheese formulation, and
the dietary fiber gel replaces an amount of fat used in an otherwise identical recipe of processed cheese that uses no dietary fiber gel.

2. Processed cheese sauce of claim 1, further comprising at least one functional food and combinations thereof selected from a group consisting of
high omega three oil, wherein high omega three oil represents 1 percent to 50 percent of the processed cheese sauce by weight,
pure omega three fatty acid, wherein pure omega three fatty acid represents 1 percent to 30 percent of the processed cheese sauce by weight,
a combination of high omega three oil and pure omega three fatty acid, wherein the total omega three fatty acid present in the combination represents 1 percent to 30 percent of the processed cheese sauce by weight,
medium chain triglyceride, wherein medium chain triglyceride represents 1 percent to 30 percent of the processed cheese sauce by weight,
fagopyritrol, wherein fagopyritrol represents 0.25 percent to 20 percent of the processed cheese sauce by weight,
lycopene, wherein the lycopene represents 0.25 percent to 20 percent of the processed cheese sauce by weight,
polyphenolic antioxidants of vegetable origin, wherein polyphenolic antioxidants represent 0.25 percent to 20 percent of the processed cheese sauce by weight,
luteine, wherein the luteine represents 0.25 percent to 20 percent of the processed cheese sauce by weight,
beta carotene, wherein the beta carotene represents 0.25 percent to 20 percent of the processed cheese sauce by weight,
calcium stearate, wherein the calcium stearate represents 0.25 percent to 20 percent of the processed cheese sauce by weight,
vitamin E, wherein the vitamin E represents 0.25 percent to 20 percent of the processed cheese sauce by weight, and
bioflavonoid, wherein the bioflavonoid represents 0.25 percent to 20 percent of the processed cheese sauce by weight.
